(19) United States
(12) Patent Application Publication
(10) Pub. No.: US 2011/0210973 A1
(43) Pub. Date: Sep. 1, 2011

(54) METHOD TO MODEL VEHICULAR COMMUNICATION NETWORKS AS RANDOM GEOMETRIC GRAPHS

(75) Inventors: Giovanni Di Crescenzo, Madison, NJ (US); Yogesh Kondareddy, Auburn, AL (US); Tao Zhang, Fort Lee, NJ (US)

(73) Assignee: TELCORDIA TECHNOLOGIES, INC., Piscataway, NJ (US)

(21) Appl. No.: 12/870,142

(22) Filed: Aug. 27, 2010

Related U.S. Application Data
(60) Provisional application No. 61/238,244, filed on Aug. 31, 2009.

(51) Int. Cl. G06T 11/20

(52) U.S. Cl. 345/440

(57) ABSTRACT

A method for generating mathematical analysis of a communication protocol in a vehicular communications network. The method defines features of a vehicular network, which may include a graph of a street map within a geographic area. A random geometric graph with a plurality of parameters is generated. A plurality of communications protocols on the vehicular network are defined. A communication protocol over the random geometric graph is redefined. A communication protocol's basic properties and associated features on the random geometric graph are analyzed. Results of the analysis are generated. The results of the analysis based on the random geometric graph's parameters are translated into results based on the vehicular network features. The random geometric graph with the parameters are displayed. The parameters may include: a number of graph nodes; and a probability that any two nodes are communicably connected being expressed as a function of the vehicular network features.

### CROSS-REFERENCE TO RELATED APPLICATION

This application claims priority under 35 U.S.C. §119(e) of U.S. Provisional Patent Application Ser. No. 61/238,244, filed Aug. 31, 2009, the disclosure of which is hereby incorporated by reference in its entirety. This application is related to the following commonly-owned, co-pending United States patent application filed on Jul. 13, 2010, the entire contents and disclosure of which is expressly incorporated by reference herein. U.S. patent application Ser. No. 12/835,001, for “METHOD FOR A PUBLIC-KEY INFRASTRUCTURE FOR VEHICULAR NETWORKS WITH LIMITED NUMBER OF INFRASTRUCTURE SERVERS”.

### FIELD OF THE INVENTION

The present invention relates to a method for mathematically analyzing vehicular communications networks, and more particularly, the present invention relates to a method for mathematically analyzing and/or modeling vehicular communications using geographical, mobility, and communication parameters.

### BACKGROUND OF THE INVENTION

Known mathematical models include modeling of wireless ad-hoc networks as random graphs with unspecified parameters, such as the number of network elements and the probability that any two such elements are connected, where the randomness may depend on various factors, such as the mobility of network nodes, the distances of these nodes, etc. Erdos graphs, often referred to as random graphs, are graphs where any two nodes are postulated to have the same independent probability of being connected. In contrast, random geometric graphs are a different type of random graphs in which connectivity of any two nodes depends on the distances between the nodes.

Wireless ad-hoc networks are communication networks where network nodes with no pre-agreed relationship can communicate using wireless messages when they are within each other's wireless radio range. The network nodes need not be vehicles, but may be, for instance, cell phones, laptops, RFID transmitters, etc., and are subject, for instance, to different mobility distribution patterns. Wireless ad-hoc networks are modeled (typically a more general type of network than vehicular networks) as random graphs or random geometric graphs with certain unspecified parameters, such as the number of network elements and the probability that any two such elements are connected. Such models have also addressed the problem of designing and analyzing communication protocols into random graphs or random geometric graphs.

For example, previous systems which are based on random graphs or random geometric graphs have the disadvantage of not offering a modeling method with quantifiable parameters. More specifically, these graphs are assumed to have a generic parameter “p” as the probability of one node reaching an edge of communication with another node, thus defining a communication radius between any two nodes. More specifically, an edge of any communication node's communication radius may not reach another node's edge of communication radius. Moreover, in previous systems, the protocol studies and analysis performed using random graphs or random geometric graphs as a mathematical model cannot be used to infer actual properties or conclusion about the original vehicular network. This is a consequence of previous systems having parameters of the random graph model that cannot be precisely related to the features of a vehicular or ad-hoc network. For example, features such as number of vehicles, geography models, communication models, or mobility models.

Known mathematical modeling of ad-hoc networks may include random graphs or random geometric graphs with unspecified parameters that cannot be related to the original vehicular networks. When a random graph or a random geometric graph is used as a model of mobile ad-hoc networks, the nodes move on a specific geographical model to form the graph. Thus, any random graph or random geometric graph solutions cannot be reliably linked to the original vehicular network.

Random graphs may define any two nodes as having the same probability of being connected, thereby being in an overlapping range of communicability. Connectivity in random graphs does not depend on the nodes' distances between each other. In contrast, in random geometric graphs, connectivity is captured in relation to the distance between nodes.

Previous solutions based on random graphs do not offer a modeling method with quantifiable parameters, in that the random graphs are assumed to have a generic parameter “n” as the number of nodes and a generic parameter “p” as the probability of existence of an edge between any two nodes. In particular, it is not known how to relate n and p to concrete features of a vehicular or ad-hoc network, such as number of vehicles, geography model, communication model, mobility model. Previous solutions based on random geometric graphs do not offer a modeling method with quantifiable parameters, in that the random graphs are assumed to have a generic parameter n as the number of nodes and a generic parameter d as the distance such that any two nodes can communicate if and only if their distance is smaller than d. Then at any given time the probability p of existence of an edge between any two nodes is the probability that the two nodes have distance at most d. Regarding random graphs, even for random geometric graphs it is not known how to relate n and p to concrete features of a vehicular or ad-hoc network, such as number of vehicles, geography model, communication model, mobility model.

Moreover, in previous systems, the protocol studies and analysis performed using random graphs or random geometric graphs as a mathematical model cannot be used to infer actual properties or conclusions about the original vehicular network. This is a consequence of the fact that the parameters of the random graph model or random geometric graph model cannot be precisely related to the features of a vehicular or ad-hoc network, such as number of vehicles, geography model, communication model, mobility model.

Regarding the issue of security in a vehicular network, both connectivity and malicious user detection issues may be handled by various techniques such as deploying vehicular roadside units (RSUs). An RSU provides network connectivity, such as a mobile server for communications, however, RSUs are costly and thus, typically not cost effective. Another technique may be to use existing public safety vehicles such as police cars as mobile servers, which could provide services normally offered by an RSU. However, the techniques such as above raise the question of how many RSU type vehicles should be added to a network to increase the connectivity and security of vehicular communications. Other shortcomings of the above technique may include the cost, maintenance, and burden on a responsible entity of implementing, maintaining, and bearing responsibility of RSUs.

It would therefore be desirable to provide a method for mathematically modeling an abstract vehicular network. Further, it would be desirable for a mathematical model to facilitate the analysis of a communications protocol used in the communications between users. Additionally, it would be desirable for a mathematical model to facilitate the analysis of connectivity and security issues, as a function of the communications, geographic, and mobility parameters of the original vehicular network.

### SUMMARY OF THE INVENTION

In an aspect of the invention, a method for generating mathematical analysis results of a communication protocol in a vehicular communications network uses a computer including a non-transitory computer readable storage medium encoded with a computer program embodied therein. The method comprises: defining features of a vehicular network, the features including: a graph of a street map within a geographic area; a number of vehicles within the geographic area; specified conditions for vehicles to communicate; and a driving distribution pattern of the vehicles; generating a random geometric graph with a plurality of parameters; defining a plurality of communications protocols on the vehicular network; redefining a communication protocol over the random geometric graph; analyzing a communication protocol's basic properties and associated features on the random geometric graph; generating results of the analysis; translating the results of the analysis based on the random geometric graph's parameters into results based on the vehicular network features; and displaying the random geometric graph with the parameters, the parameters including: a number of graph nodes, a probability that any two nodes are communicably connected being expressed as a function of the vehicular network features.

In a related aspect, the communications protocol's basic properties include: communication latency, and bandwidth; and wherein the associated features include: a number of nodes required to guarantee a given number of neighbors for each node. The method may also include the translating step comprising combining the results of the communication protocol's analysis based on the random geometric graph's parameters with the expression calculating the random geometric graph parameters as a function of the vehicular network features. The method may further include: calculating a number of neighbors of one of the plurality of nodes; and calculating a number of neighbors of one of the plurality of nodes which is specified as an adversary node. At least a portion of the communication nodes may be mobile. The method may further include: calculating how many infrastructure mobile servers are required to attain a specified connectivity between the plurality of vehicles.

In another aspect of the invention, a method for generating a mathematical model including analysis results of a vehicular communications network using a computer including a non-transitory computer readable storage medium encoded with a computer program embodied therein, comprises: defining a vehicular communications network including a plurality of vehicles-using the computer program; defining a plurality of communication nodes communicating with the plurality of vehicles; defining features of the vehicular communications network, including: geographic locations; mobility features; and communication features; generating a geographical model, a mobility model, and a communication model of the vehicular communications network using the computer program;

generating a spatial distribution of the plurality of vehicles defining locations in relation to time of the plurality of vehicles in the vehicular communications network; calculating a probable radius of location for each of the plurality of communications nodes; defining a radius parameter for each of the plurality of vehicles such that each of the plurality of vehicles communicates within the radius parameter; calculating a probability that two edges of the probable radiuses intersect using the spatial distribution, such that a distance between the communication nodes is smaller than the radius parameter; generating a mathematical model of the vehicular communications network; generating a random geometric graph with a plurality of parameters; and displaying the random geometric graph on a display.

In a related aspect, the method further includes: providing a plurality of communications protocols on the vehicular network; redefining a communication protocol over the random geometric graph; analyzing the redefined communication protocol's basic properties and associated features on the random geometric graph; generating results of the analysis; translating the results of the analysis based on the random graph's parameters into results based on the vehicular network features; and displaying the random geometric graph with the parameters on the display, the parameters including: a number of graph nodes; and a probability that any two nodes are communicably connected being expressed as a function of the vehicular network features. The communications protocol's basic properties may include: communication latency, and bandwidth; and wherein the associated features include: how many nodes are needed to guarantee a given number of neighbors for each node. The method may include features of: a graph of a street map within a geographic area; a number of vehicles within the geographic area; and a driving distribution pattern of the vehicles; The method of claim 7, wherein a Certificate Revocation List (CRL) is sent between the plurality of vehicles, and between the plurality of communication nodes and the plurality of vehicles. The method may further include calculating a number of neighbors of one of the plurality of nodes. The method may further include: calculating a number of neighbors of one of the plurality of nodes being specified as an adversary node; and providing a specified number of communication nodes in the vehicular communications network. At least a portion of the communication nodes may be mobile. The method may further comprise: calculating how many infrastructure mobile servers are required to attain a specified connectivity between the plurality of vehicles. The geographical model may include a Manhattan Grid Mobility model (MGMM).

In another aspect of the invention, a computer program product comprising a non-transitory computer readable medium having recorded thereon a computer program, a computer system including a processor for executing the steps of the computer program for generating a mathematical model, the program steps comprising: defining features of a vehicular network, the features including: a graph of a street map within a geographic area; a number of vehicles within the geographic area; specified conditions for vehicles to communicate; and a driving distribution pattern of the vehicles; generating a random graph with a plurality of parameters; defining a plurality of communications protocols on the vehicular network; redefining a communication protocol over the random graph; analyzing a communication protocol's basic properties and associated features on the random graph; generating results of the analysis; translating the results of the analysis based on the random graph's parameters into results based on the vehicular network features; and displaying the random graph with the parameters, the parameters including: a number of graph nodes, a probability that any two nodes are communicably connected being expressed as a function of the vehicular network features.

In a related aspect, the computer program product includes a feature wherein the communications protocol's basic properties include: communication latency, and bandwidth; and wherein the associated features include: a number of nodes required to guarantee a given number of neighbors for each node.

### BRIEF DESCRIPTION OF THE DRAWINGS

These and other objects, features and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. In the drawings:

FIG. 1 is a graph depicting a m×m grid of sample roads according to an embodiment of the invention;

FIG. 2 is a three dimensional graph depicting spatial distribution of nodes in a Manhattan Grid Mobility Model (MGMM) according to an embodiment of the invention;

FIG. 3 is a sample street map depicting locations or nodes A-D;

FIG. 4 is a three dimensional graph depicting spatial distribution of nodes A-D shown in FIG. 3, in an MGMM according to an embodiment of the invention;

FIG. 5 is a flow chart illustrating a method according to an embodiment of the invention for providing a mathematical model of a vehicular communications network;

FIG. 6 is a continuation of the flow chart illustrated in FIG. 5 for providing a mathematical model; and

FIG. 7 is a schematic block diagram depicting an embodiment of a computer system for use in providing a mathematical model of a vehicular communications network according to an embodiment of the invention.

### DETAILED DESCRIPTION OF THE INVENTION

A vehicular network is a communication network between vehicles, wherein the vehicles are capable of communicating with each other. Generally, the present invention includes a method providing a mathematical model representing an abstract vehicular network. In one embodiment, designated network servers may be physically located proximate to the vehicles or a specified distance from a vehicle, and have a communication distance depending on the wireless capabilities of the transmitting and receiving devices. Further, properties inferred during an analysis of an associated mathematical model can be used for various purposes, including, for example, protocol solution comparison, and improved protocol design. For instance, any communication protocol implemented between the vehicles in the vehicular network can be designed and analyzed in, for example, a random geometric graph. In the random geometric graph, all network elements are vertices of a graph, wherein two vertices are connected if and only if their distance is below a certain parameter (reflecting the “geometric” attribute), and a probability exists that any two nodes are connected.

In an embodiment of a method according to the present invention, features of a vehicular network provide a random geometric graph with parameters (e.g., the number of graph nodes, and the probability that any two nodes are connected) related to features of the vehicular network. The features of the vehicular network include, a certain geographic area, the number of vehicles within the same area, and the driving distribution pattern of these vehicles. In an aspect of the method, the method analyzes a protocol's basic properties (such as communication latency, bandwidth, etc.) and any associated features (such as how many nodes are needed to guarantee a given number of neighbors for each node) on a random geometric graph, and translates the results of the analysis in terms of the vehicular network features.

Generally, the method according to one embodiment of the present invention, defines a vehicular network using basic features of a vehicular network, for example, geography, mobility, and communication. The basic features are used to generate, geographic, mobility, and communication models. The method further provides a distribution or positioning or location, at any given time, of the vehicles. Using the distribution, the method calculates the probability that any two edges are connected, i.e., the vehicle positions have a distance smaller than a radius parameter r, representing the communication radius of a node. This probability is the same for any two nodes, and thereby a random geometric graph is obtained. Note that the probability that a third node is connected to any one of the two connected nodes is not the same as before, and thereby a random graph is not applicable.

In the present invention, a general embodiment according to the invention formulates a geographical, mobility, and communication model, wherein the results are represented in a spatial distribution of nodes (representing vehicles) which are stationary. The model is used to prove that vehicles form a kind of random geometric graph with n nodes and edge probability p, where n and p have a closed-form expression. This result is applied to general geographical, mobility, and communication models, and obtains a random geometric graph with n nodes and edge probability p, where n and p have an algorithmically computable expression. Thus, properties of mobile ad-hoc or vehicular networks can be measured and analyzed, such as connectivity and related security questions, as a function of basic communication, geographic and mobility parameters. Properties may include, for example, security issues, including how many infrastructure mobile servers are required to improve connectivity, and malicious user detection in a vehicular network.

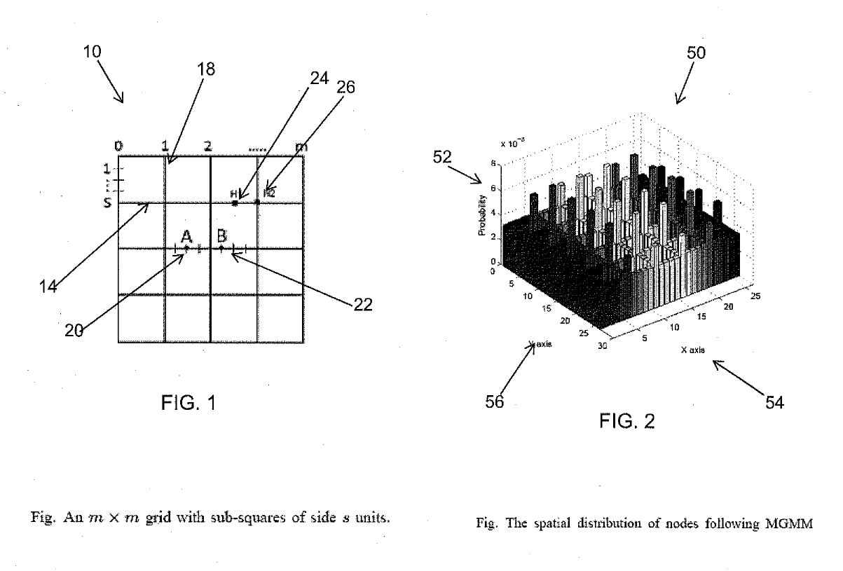

Referring to FIG. 1, an embodiment of the invention includes a solution using a simplified set of geographic, mobility, and communication models. The simplified geographical model, for example, a (m×m) grid 10, with sub-squares (m²) having the same area. The grid 10 also has of side units (s) depicting distances. The grid's m+1 horizontal lines 14, also called rows, and m+1 vertical lines 18, also called columns, represent the roads in the horizontal and vertical directions, respectively. Each side of a sub-square is divided into s units. The geographic model is, for simplicity, assumed to be fixed in time.

The number of vertical roads 18, are depicted by units 0 through m at the top of the graph. The number of horizontal roads 14, are depicted by units 0 through “s” on the side of the graph. The simplified mobility model, includes: a Manhattan Grid Mobility Model (MGMM). A simplified communication model, includes: circular coverage with radius r, and two nodes that can communicate if the distance between them is less than r. The grid 10 is also used in the simplified communications model. Points on the grid 10 include nodes A and B 20, and 22, respectively, depict the probability that a vehicle is at their location on the grid. Other points, H1 and H2, 24 and 26, respectively, depict geometric points for location purposes.

Geometric random graphs are a variant of random graphs, and may be applied to vehicular networks. Referring to FIG. 1, the grid 10 is formed by representing a node (which may be a vehicle) as a vertex and the communication link between two vehicles as an edge. The grid 10 changes with time and is a snapshot of such a dynamic graph at any point of time is a result of: a) movement of vehicles following a mobility model; b) restricting the graph to a fixed geography; and c) a communication model which defines the connection between nodes.

The probability distribution of the nodes can be obtained as below:

$${f}_{XY} ( x , y ) = \{ \begin{matrix}\frac{1}{P} & for ( x , y ) ∈ {H}_{1} \\ \frac{2}{P} & for ( x , y ) ∈ {H}_{2} \\ 0 & otherwise\end{matrix} \\ P = 2 ( sm + 1 ) ( m + 1 ) .$$

Referring to FIG. 2, the spatial distribution of nodes is shown following MGMM. The distribution map (also referred to as random geometric graph) 50 includes a probability on the Z axis, and demarcations of the “X” and “Y” axis 54, 56, respectively, depicting street locations. The distribution shows the probability of vehicles on the grid. Individual nodes are depicted to show the probability of a single vehicle on the distribution map 50. In the above formula, the F[xy] is a stationary distribution. At any time t, the communication graph, G(t)=(V,E(t)) is a random geometric graph. P is the probability of an edge between any two nodes and is (approximately) given by:

$${p}_{e} \approx \frac{1}{{sm}^{2}} [ ( 4 {\sum }_{i = 1}^{⌊ \frac{r}{s} ⌋} ⌊ \sqrt{{r}^{2} - {( i \times s )}^{2}} ⌋ ) + r ]$$

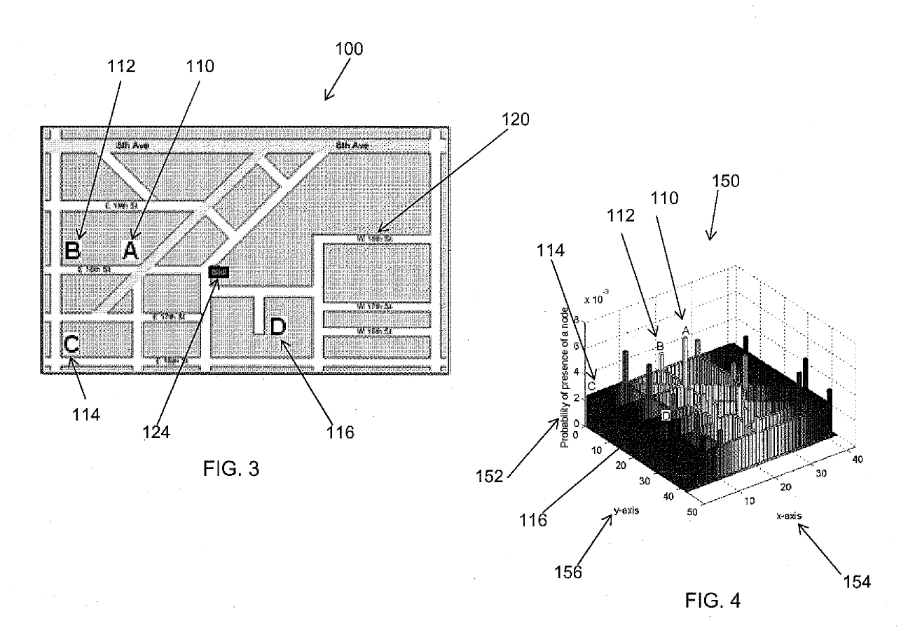

In the formula above, there is direct dependence on parameters s, m of a geographic model, and r of a communication model of a vehicular network. The dependence from the mobility model is intrinsic in the formula itself. A generalized set of geographic, mobility, and communication models include, a Generalized Communication Model, which includes: the analysis generalized to any arbitrary coverage area; and the presence of a spatial distribution is not affected. A Generalized Geographical Model, includes: fixed mobility and communication models, and a generalized geographical model, which may be simulated on a sample area in a sample street map 100, as shown in FIG. 3, with nodes following MGMM.

Referring to FIG. 3, street map 100 includes four nodes A-D, wherein all the nodes A 110, B 112, C 114, D 116 are located on the map 100. The map 100 is a sample street map with enumerated roads, for example, road 120. The nodes A-D 110-116, respectively, are possible locations of vehicles at a given time, such as exemplary vehicle 124.

Referring to FIG. 4, a random geometric graph 150 includes the nodes A-D 110-116, respectively, with the bars of the graph extending in the z direction 152 to show the probability of presence of a node on the grid such as the street map of FIG. 3. The X 154 and Y 156 axis of the graph 150 provide a grid for determining location in the graph 150.

A Generalized Mobility Model, may include, a finite state irreducible Markov chain. Points on the geographical model represent states. Transition probabilities are defined by a mobility model. A unique stationary distribution exists. The chain converges regardless of where it begins. The conclusions are shown in the graph distribution 150 in FIG. 4 using the theory of Markov chain.

The present invention defines communication, geographic and mobility models, and then shows that these models imply a random geometric graph where the probability of edge existence either has a closed-form expression (e.g., in the case of well-studied or simplified communication, geographic and mobility models), or is algorithmically computable, in the case of generalized models. The relationships between the obtained random geometric graph's parameters and the features (e.g., communication, geographic and mobility models) of the vehicular network, provide a method to obtain quantifiably related properties for associated vehicular networks, given properties of a communication protocol over a random geometric graph. Overall, the present invention obtains results by combining various skills, including, for example: mathematical modeling, probability calculations, and Markov chain theory, vehicular networks, probability theory, etc.

In an embodiment of the invention, a method includes a geographical model such as a Manhattan grid, and deploying vehicles which follow a mobility model such as a Manhattan Grid Mobility model. The graph formed by the vehicles at any point of time “t”, is a random geometric graph with n nodes and edge probability p. The method includes calculating the number n of nodes from the number of vehicles in the vehicular network, for example, via a closed form formula that is based on the density of vehicles in the specific geographic area considered and the number of active vehicles at any given time during the day (both numbers being well known by publicly available vehicle distribution statistics). The method includes calculating the parameter, p via a closed form, and when the models are well defined, generalizing the analysis to algorithmically calculate p for any communication model and geographical map. The method of the present invention includes mobility models defined for mobile ad-hoc networks which result in a graph which can be represented as a random geometric graph. The method provides: a) given a studied communication, geographical, and mobility models, the vehicles form a random geometric graph with n nodes and edge probability p that can be expressed with a closed form; b) defined rigorous conditions under which generalized communication, geographical, and mobility models result in a random geometric graph with an algorithmically computable number of nodes n and edge parameter p. The method provides at least knowledge of the conditions under which the use of random geometric graphs as models of ad-hoc and/or vehicular networks may be reasonable.

Security in vehicular networks may include digitally signing messages sent between vehicles, using a vehicle's certificate of authentication and a Certificate Revocation List (CRL). Security involving issuing and revoking certificates may be handled by a centralized Certification Authority. In a vehicular network without infrastructure, there is no centralized Certification Authority (CA), therefore, the vehicles themselves may detect and revoke a malicious user. Further, the nodes in a decentralized vehicular network have to verify the data using decentralized detection techniques. In one example decentralized technique an adversary's neighbors play an important role in verifying the messages. The more neighbors the adversary has, the higher the probability of detecting the adversary. Revoking is done in by broadcasting a CRL. The CRL propagates to all the nodes very quickly before the adversary goes to a different location and can cause further damage. In the vehicular network without infrastructure, propagation of messages relies on multi-hop communication, and thus, connectivity of the network is important.

In the embodiments of the present invention, the results of random geometric graphs are applied to vehicular networks. Also, the present invention calculates the additional infrastructure required to increase the node degree (number of neighbors in a vehicular network) to a required level. Simulations are used to visualize and verify the analysis. Embodiments of the invention are as follows.

Random Geometric Graphs Using Closed Formulas with Specific Geometric, Mobility and Communications Models

In one embodiment of a method according to the present invention the method finds random geometric graphs, using closed formulas, starting from specific geographic, mobility and communication models. The method shows that the above parameters induce the existence, at any given time, of a random geometric graph among the vehicles, where the number of nodes and the edge parameter can be expressed, using a closed formula, as a function of basic parameters from the geographic and communication model. The method includes formally defining the specific geographic, mobility and communication models, then analyzing the spatial distribution of nodes over time, and finally showing that the distribution induces a random geometric graph.

In embodiments of specific geographic, mobility and communication models, a geographic model defines the set of possible vehicle positions. Referring to FIG. 1, the geographic model, grid 10, includes n vehicles (or nodes), and, for simplicity, n is assumed to be fixed in time. (Alternatively, the number n of nodes can be computed from the number of vehicles in the vehicular network, for example, via a closed form formula that is based on the density of vehicles in the specific geographic area considered and the number of active vehicles at any given time during the day, both numbers being well known by publicly available vehicle distribution statistics.) For i=1, . . . , n, the i-th node is associated with a position, represented, at time t as Pᵢ (t)=(xᵢ (t), yᵢ (t)), where either xᵢ (t)ε{0, . . . , ms} and yᵢ(t)ε{0, . . . , m} (on horizontal lines), or xᵢ(t)ε{0, . . . , m} and yᵢ(t)ε{0, . . . , ms} (on vertical lines). The initial positions of all nodes, denoted as Pᵢ(0), for i=1, . . . , n, are chosen randomly and independently among the above feasible values. One of the n nodes can be an adversary, whose index and position are denoted as advε{1, . . . ,} and P_{adv}(t), respectively.

Mobility model. The mobility model defines the law under which the vehicle positions evolve over time. In this section is considered an instance of the Manhattan Grid Mobility Model (MGMM) which can be seen as a modified discrete random walk on the graph determined by the grid defined in the geographic model, the modification consisting of a particular set of constraints on choosing the direction.

For i=1, . . . , n, the i-th node is associated with a direction, represented, at time t as dirᵢ(t)ε{U,D, L,R} (for up, down left, right), where dirᵢ(t)ε{L,R} on horizontal lines and dirᵢ(t)ε{U,D} on vertical lines. The model below is considered a wrap around model, meaning that a node moving outside of the grid on one of the four sides enters again on the grid on the opposite side. The initial directions of all nodes, denoted as dirᵢ(0), for i=1, . . . , n, are chosen randomly and independently among the above feasible values. Assumed is a discrete time scale, where at each time step the nodes perform one additional movement step along their directions, according to the MGMM mobility model. Referring to FIG. 1, an m×m grid includes sub-squares of side s units. Specifically, at each time step each node is allowed to independently move in all possible directions along the horizontal and vertical lines on the grid. At an intersection of a horizontal and a vertical line, the node can turn left, right, go straight or take a u-turn with a certain probability. The node is not allowed to change its direction when it is on a line segment connecting two intersection points. This restriction captures the fact that in real life vehicles are either not allowed or much less likely to take u-turns in between traffic signal points (cross-over points). The formal definition of the MGMM model is obtained by formally defining the evolution of Pi(t), diri(t), for all i=1, . . . , n, and all t≧1 (the case t=0 being defined above), as follows:

if (xᵢ(t)≡(0 mod s)) [symbol] (yᵢ(t)≡(0 mod s)), then:

$${dir}_{i} ( t + 1 ) = \{ \begin{matrix}U with probability \frac{1}{4} \\ D with probability \frac{1}{4} \\ L with probability \frac{1}{4} \\ R with probability \frac{1}{4}\end{matrix}$$

else, dirᵢ(t+1)=dirᵢ(t);

if (xᵢ(t)≡(0 mod s)) and diri(t)=U, then: Pi(t+1)=(xi(t), yi(t)+1);

if (xᵢ(t)≡(0 mod s)) and diri(t)=D, then: Pi(t+1)=(xi(t), yi(t)−1);

if (yᵢ(t)≡(0 mod s)) and diri(t)=L, then: Pi(t+1)=(xi(t)−1, yi(t));

if (yᵢ≡(0 mod s)) and diri(t)=R, then: Pi(t+1)=(xi(t)+1, yi(t)).

An adversary model is assumed to follow the same mobility model as all other nodes in the network.

A communications model, defines the conditions under which any pair of vehicles can or cannot communicate. A communication range, also called coverage area, for each node, is defined as a circle of radius r having the node as its center. V is the set of all vehicles represented as nodes and E(t) is the edges between these nodes at time t. Then, the communication graph G(t)=(V,E(t)) at time t is defined as the graph formed by nodes in V and edges such that (i, j)εE(t) if and only if ∥(Pᵢ(t), Pⱼ(t))∥≦r, where ∥·∥ is the Euclidean distance metric.

Also defined is the neighbor set of a node i at time t, as the set of nodes in V\i which are in i's communication range at time t; more formally defined as Ni(t)={jεV: ∥(Pᵢ(t), Pⱼ(t))∥≦r}.

The spatial distribution of nodes define the distribution, at any given time t, of the position of each node within the geographic model, as a result of the initial placement of the node (at time 0) and of t steps carried under the laws in the mobility model. Using defined geographic, mobility and communication models, there exists a spatial distribution of the nodes that is stationary (i.e., it does not vary with the time variable t, regardless of the changes due to the mobility model). This holds true regardless of the distribution of the initial placement of the n nodes.

More specifically, given a probability space, a (discrete-time) stochastic process S is defined as a collection of random variables defined over the probability space and indexed by a discrete time variable; i.e., S={S(t)|t=0, 1, 2, . . . }. A discrete-time stochastic process is stationary if for all integers k≧0, all integers τ≧0, it holds that the joint distribution of random variables (S(1+τ), . . . , S(k+τ)) does not depend on τ. Let P>0 be a parameter (to be later computed), and consider the 2-dimension random variable (X, Y) distributed according to the following distribution:

$${f}_{XY} ( x , y ) = \{ \begin{matrix}\frac{1}{p} & for ( x , y ) ∈ {H}_{1} \\ \frac{2}{p} & for ( x , y ) ∈ {H}_{2} \\ 0 & otherwise\end{matrix}$$

where,

H={(x,y):(0≦x≦ms) [symbol] (0≦y≦ms) [symbol] ((x mod s)=0 [symbol] (y mod s)=0)}

H₂={(x,y):(x,y)εH [symbol] (x mod s)=0 [symbol] (x≠0) [symbol] (x≠ms) [symbol] (y mod s)=0 [symbol] (y≠0) [symbol] (y≠ms)}

H₁={(x,y):(x,y)εH [symbol] (x,y)∉H₂}.

Given s, m, and by direct counting over the grid, closed-form expressions can be derived for |H₁|, |H₂| and |H|, as follows: |H₁|=2(s−1)m(m+1), |H₂|=(m+1)2, and |H|=|H₁|+|H₂|=2sm²+2sm−m²+1.

Then, a closed-form expression can be found for P by observing that (1/P)|H₁|+(2/P)|H₂|=1, and thus obtaining P=(|H₁|+2|H₂|)=2(sm+1)(m+1). Letting Si be the discrete-time stochastic process defined as Sᵢ(t)=(Xᵢ(t), Yᵢ(t)) for all integers t≧0. Here, Sᵢ(t) represents the position of a node i at time t. Then, the spatial distribution results of nodes can be stated as follows.

Theorem 1 is as follows. In the probability space of the mobility model above, (S1, . . . , Sn) denotes the discrete-time stochastic process describing the positions of all n nodes. If Si(0)=fXiYi (x, y) for i=1, . . . , n, then (S1, . . . , Sn) is stationary. As a proof, the MMGM mobility model acts independently on each node. Then, by the definition of stationary stochastic processes, if each process Si is stationary then so is process (S1, . . . , Sn). The proof that process Sᵢ is stationary is done by induction over k, where the base case k=1 is proved by induction over t.

If k=1, a prove is needed that Si(t)=fXi(t)Yi(t)(x, y) for all t≧0. This is proved by induction over t. The base case t=0 directly follows by the theorem's hypothesis. Assuming that this fact is true when t=u; that is, Si(t)=fXi(t)Yi(t)(x, y) for t=1, . . . , u, and considering Si(u+1). The result is that Si(u+1)=a for aεH1 either with probability (1/P)*(1/2)+(1/P)*(1/2)=1/P (in correspondence of points like point A in FIG. 1) or with probability (2/P)*(1/4)+(1/P)*(1/2)=(1/P) (in correspondence of points like point B in FIG. 1), and Si(u+1)=a for aεH2 with probability 4*(2/P)*(1/4)=2/P. This proves the claim when k=1.

Assuming that the claim holds for k≦q, thus implying that the distribution of (Si(1+τ), . . . , Si(q+τ)) does not depend on τ, the distribution of (Si(1+τ), . . . , Si(q+τ), Si(q+1+τ)) does not depend on τ. Because of the induction hypothesis, this will not happen only if the distribution of Si(q+1+τ), conditioned by Si(1+τ), . . . , Si(q+τ), is not independent on τ. However, by definition of fXY, Si(q+1+τ) only depends on Si(q+τ) and thus the distribution of Si(q+1+τ), conditioned by Si(1+τ), . . . , Si(q+τ) can be written as the distribution of Si(q+1+τ), conditioned by Si(q+τ). This latter distribution is independent on τ, or otherwise the induction hypothesis for q=2, is contradicted.

Random geometric graphs are discussed below. At any time t, the communication graph G(t)=(V,E(t)) is a random geometric graph; i.e., it includes n nodes, any two nodes are connected if and only if their positions are at distance less than r, and any two nodes are connected with the same probability p. In one embodiment of the method of the present invention, the parameter p can be expressed as a closed formula of parameters m, s, r. Assuming s is odd and (r mod s)=[s/2], the probability of an edge, pₑ as:

$${P}_{e} = \frac{4 m ( m + 1 )}{P} ( {\sum }_{d = 1}^{⌊ \frac{s}{2} ⌋} ξ ( α , β , d ) ) + \frac{2 {( m - 1 )}^{2} ξ ( α , β , o )}{P}$$

$$where , \\ ξ ( α , β , d ) = \frac{1}{P} [ \begin{matrix} ( 4 {\sum }_{i = 1}^{\frac{r}{s}} ⌊ \sqrt{{r}^{2} - {( i \times s )}^{2}} ⌋ ) + 2 ⌊ \frac{r}{s} ⌋ + 2 r + 1 + \\ 2 {\sum }_{i = 1}^{α} ⌊ \sqrt{{r}^{2} - {( ( 1 \times s ) - d )}^{2}} ⌋ + α + ( 2 {\sum }_{i = 1}^{β} ⌊ \sqrt{{r}^{2} - {( ( i - 1 ) s + d )}^{2}} ⌋ ) + β\end{matrix} ]$$

$$α = ⌊ \frac{1}{2} ⌈ \frac{2 r}{s} ⌉ ⌋ and β = ⌈ \frac{1}{2} ⌈ \frac{2 r}{s} ⌉ ⌉ .$$

Theorem 2 is as follows. Assuming the initial placement of the n nodes follows the distribution fxy, and given the grid geographic model, the mobility model, and the communication model above at any given discrete time t≧0, the communication graph G(t)=(V,E(t)) is a random geometric graph with n nodes and edge probability p having the closed-form expression pₑ (when s is odd and r=s/2 mod s). The stationary distributions of the nodes guaranteed by Theorem 1 result in proving Theorem 2 requiring calculating pₑ, as follows: first, computing the number of grid intersection points and of grid non-intersection points in the circle of radius r having a node as a center; second, multiply these two numbers by the respective probabilities under the stationary distribution. An approximation is embodied as the following formula:

$${P}_{e} \approx \frac{1}{{sm}^{2}} [ ( 4 {\sum }_{i = 1}^{\frac{r}{s}} ⌊ \sqrt{{r}^{2} - {( i \times s )}^{2}} ⌋ ) + r ] .$$

From the above equation, it is observed that when r≈s, pₑ is ≈cr2/s2m2, which means pₑ is proportional to the ratio of area of the communication circle to the area of the total grid and when r<<s, pₑ≈cr/sm².

In an example of the application of Theorem 2, the distribution of the number of neighbors |Ni(t)| of node i at time t can be calculated as follows. Let Zi(t) be the set of points on the grid which are in the communication range of the node i at time t; i.e., Zi(t)={(x, y): (x, y) εt [symbol] ∥(x, y), (xᵢ, yᵢ)∥≦r} and define k1=(H1 ∩Zi(t)), k2=(H2 ∩Zi(t)). Then, the probability that a node j is connected to node i at time t is the probability that node j's position is in k1 ∪k2. Theorem 1 implies that each node position is a specific stationary stochastic process Sj, and thus, if all nodes are initially placed according to the stationary distributions S1= . . . =Sn, the probability is that a node j is connected to node i at time t is pe=|k₁|/P+2|k₂|/P, which has been previously computed in a closed form expression.

Thus, the probability distribution g(|Ni(t)|) of i's number of neighbors |Ni(t)| at time t is binomial with parameters n−1 and pe; i.e.,

$$g ( \vert {N}_{i} ( t ) \vert ) = B ( n - 1 , \frac{{k}_{1}}{P} + \frac{2 \vert {k}_{2} \vert}{P} ) .$$

The expected value and variance of |Ni(t)| are easily computable as (n−1)pₑ and (n−1)pₑ(1−pₑ). Moreover, the total number of edges in the graph, T(t), can be written as T(t)=(1/2) Σⁿᵢ=1|Ni(t)|, where the variables Ni(t) are pairwise independent (but not 3-wise independent.

Therefore, in the discussion above it is shown that given well-known geographical, mobility and communication models, the communication graph is a random geometric graph where the edge parameter can be expressed as a closed formula of parameters r, s, m from the geographic and communication model.

Random Geometric Graphs Algorithmically Computed with Generalized Geometric, and Mobility Models

The results discussed above are extended by generalizing each of the models considered in the previous section, which results in the communication graph as a random geometric graph where the edge parameter can be algorithmically computed (with efficient running time). In an embodiment of a generalized communication model, a given fixed geographical and mobility model, such as discussed in the previous section, the communication model is generalized and the consequences are studied on a communication graph. The analysis may include a circular coverage area, or be generalized to any arbitrary coverage area. For example, using a squared coverage area, a closed-form expression (as a function of m, r, s) was obtained for the random v geometric graph edge parameter p. More generally, a communication range can be considered as an arbitrary two dimension shape. Since the spatial distribution of nodes on the grid only depends on the mobility and geographic model, such a change in the communication range of the nodes does not affect the computation of value P (as a function of m, s) or the stationarity of the spatial distribution of nodes (as calculated in Theorem 1). Because the stationarity of this distribution suffices to obtain a random geometric graph with n nodes and the same edge probability pₑ in Theorem 2, a random geometric graph is obtained even when the communication range is an arbitrary two dimension shape. The value pₑ changes as it is dependent on the values of k₁, k₂, which directly depend on the communication range shape. However, a procedure properly generalizing to an arbitrary two dimensional shape would suffice to compute the new pₑ value.

Generalizing the geographic model, given a fixed mobility model, and a fixed communication model, a method according to the present invention generalizes the geographical model. In an embodiment of the invention, a geographical model of an arbitrary street map is abstracted as a planar graph Gmap=(Vmap,Emap), where Vmap is the set of all intersections or junctions on the street map, and Emap is the set of all streets joining any two intersections. Moreover, to each edge in Emap one could associate a weight proportional to the street length (thus further generalizing the constant parameter s in the grid). To find a stationary distribution over the grid generalized to an arbitrary graph Gmap, where the distribution is as follows:

$$fXY ( x , y ) = \{ \begin{matrix}\frac{deg ( {v}_{x , y} )}{P} & for ( x , y ) ∈ A \\ 0 & otherwise\end{matrix}$$

for some value P such that Σ_{∀(x,y)}f XY (x, y)=1
and where vx,y is a node from Vmap having position (x, y) and deg(vx,y) is its degree in Gmap.

This means that the probability of finding a node at a point v_{x,y} is proportional to the number of directions that point can be reached at. With the new stationary distribution, a similar analysis as used in the section above can be used to calculate the new edge probability pₑ.

### Specifically:

Pₑ=Σᵥ_{_{x,y}}pr(i,v_{x,y})·pr(i,j,v_{x,y}),
where pr (i, v_{x,y}) is the probability that node i is on point v_{x,y},pr(i, j, v_{x,y}) is the probability that node j is connected to node i, given that the latter is on point v_{x,y}, and

$$pr ( i , j , {v}_{x , y} ) = {\sum }_{x , y ∈ {Z}_{i}} f XY ( x , y )$$

Thus, nodes moving with Manhattan mobility and a fixed communication model will still form a random geometric graph on the generalized geographical model defined above, although with different values for the edge parameter pₑ.

In order to generalize the mobility model, given fixed communication and geographic models such as generalized above, the mobility model is generalized and the consequences studied on the communication graph. The method of the present invention generalizes the mobility model and provides the existence of a stationary spatial distribution of nodes which will result in a random geometric graph. The MGMM mobility model can be significantly generalized, and the generalization will allow the existence of a unique stationary distribution such that, regardless of the initial node deployment, the spatial distribution converges to this distribution.

In general terms, a mobility model is an arbitrary probabilistic function, that at any given time given the entire history of the nodes' movements on the geographic model, returns the next nodes' movements. A definition of a mobility model for vehicular networks may be restricted such that the movements of each node only depends on a finite number of positions of the same node.

Using the above generalized geographic and mobility model, a finite state Markov chain can be constructed as follows. First, assuming the mobility model says that the movement of each node only depends on the current position of the same node, then, the Markov chain's states represent the points on the geographical model (FIG. 1) and transition probabilities are directly defined by the mobility model. Since any point on a map can be reached from any other point on the map, the Markov chain is formed by mapping points on the map to states holding the same property. This makes the Markov chain irreducible. The extension to the more general mobility model where the movements of each node depend on a finite number of positions of the same node is obtained by a standard technique in the area of Markov chains that blows up the original state space V into a larger space Va. One drawback is that operations over the resulting Markov chain are exponential in a, so one would only have efficient algorithms in the cases when a=1 or a is small. The necessary and sufficient condition for such a Markov chain to have a stationary distribution is as follows: If the Markov chain is a time-homogeneous Markov chain, so that the process is described by a single, time-independent transition matrix, then an irreducible chain has a stationary distribution if and only if all of its states are positive recurrent.

Also, in the case of a time-homogeneous Markov chain, the stationary distribution is unique. There is no assumption on the starting distribution, the chain converges to the stationary distribution regardless of where it begins. In the present embodiment, a finite irreducible Markov chain is used. Finite irreducible chains are known to be always recurrent. As a result, there exists a unique stationary distribution regardless of how the nodes were deployed initially. Thus, a unique stationary distribution that can be computed efficiently is obtained. Therefore, any mobility model which defines time-homogeneous transition probabilities from one point to another point on the finite geographical model defines an irreducible, recurrent Markov chain which will have a unique stationary spatial node distribution. Once a stationary distribution is derived, a random geometric graph is obtained as in the proof of Theorem 2 above, and the edge parameter pₑ can be calculated as above. Thus, is obtained the following: Theorem 3: assuming an arbitrary distribution on the initial placement of the n nodes, given the generalized geographic, mobility, and communication models (as described above) at any discrete time t≧0, the communication graph G(t)=(V,E(t)) is a random geometric graph with n nodes and edge probability p, where p has an expression that is algorithmically computable (with efficient run time).

Applications in Vehicular Networks

In an embodiment of the invention, an example is shown of a method of an analysis of the properties of a communication protocol over a vehicular network, by generating the associated random geometric graph, analyzing the protocol over the random geometric graph and then translating the results over the vehicular network. This is a result of the expression of the random geometric graph's parameters as a function of the vehicular network features.

Specifically, the communication protocol is a neighbor-based protocol where a vehicle seeks response from all other vehicles in its radio range regarding building awareness of a local situation, with respect to aspects such as connectivity or security. In what follows, we give a specific example motivated by security aspects. In a vehicular network without infrastructure, there is no central authority to judge if a message is correct or not. The nodes verify the data using decentralized detection techniques. In such decentralized techniques, an adversary's neighbors play an important role in verifying the messages. The more the number of neighbors of the adversary, the higher will be the probability of detecting the adversary. Similarly, connectivity of the network is closely related to the number of neighbors of a node. A higher value of expected number of neighbors of a node increases the probability of connectivity of the network. A communications graph G(t)=(V,E(t)) is a random geometric graph with edge probability pe, the expected number of neighbors of a node can be easily calculated and is equal to (n−1)pₑ. The exact number of neighbors of the adversary can also be computed when the radius, radv and position of the adversary, (xadv, yadv) are given, using a binomial distribution, B(n−1, ζα,β,d). Variables are defined as: d in this case is the displacement of the adversary's position from the nearest intersection and is equal to, d=[min((x mod s), s−(x mod s))+min((y mod s), s−(y mod s))]. The expected value is (n−1)ζα,β,d and the variance is (n−1)(ζα,β,d(1−ζα,β,d)). Using this ability to calculate the number of neighbors of a node, practical questions can be answered, for instance: how many mobile infrastructure vehicles (e.g., police cars with additional capabilities) should be added to the network to increase the neighbor density such that the connectivity and security of vehicular communications (via a more accurate detection of message correctness) are significantly improved. These calculations reduce to solving inequalities with binomial probabilities using as a parameter the vehicular network edge probability pₑ. Note that the edge probability pₑ can be expressed as a function of the vehicular network features, and therefore any inequality solution for pₑ translates directly to a condition on the vehicular network features.

### CONCLUSION

The method of the present invention provides a network model by formally defining communication, geographic and mobility models. The model imply a random geometric graph with n nodes and edge probability p, among the nodes, where n and p have a closed-form expression in the case of simplified models, or is algorithmically computable, in the case of generalized models. Further, the present invention provides a method of designing and analyzing, for example, communication protocols in a vehicular network, and unspecified parameters using random graphs or random geometric graphs.

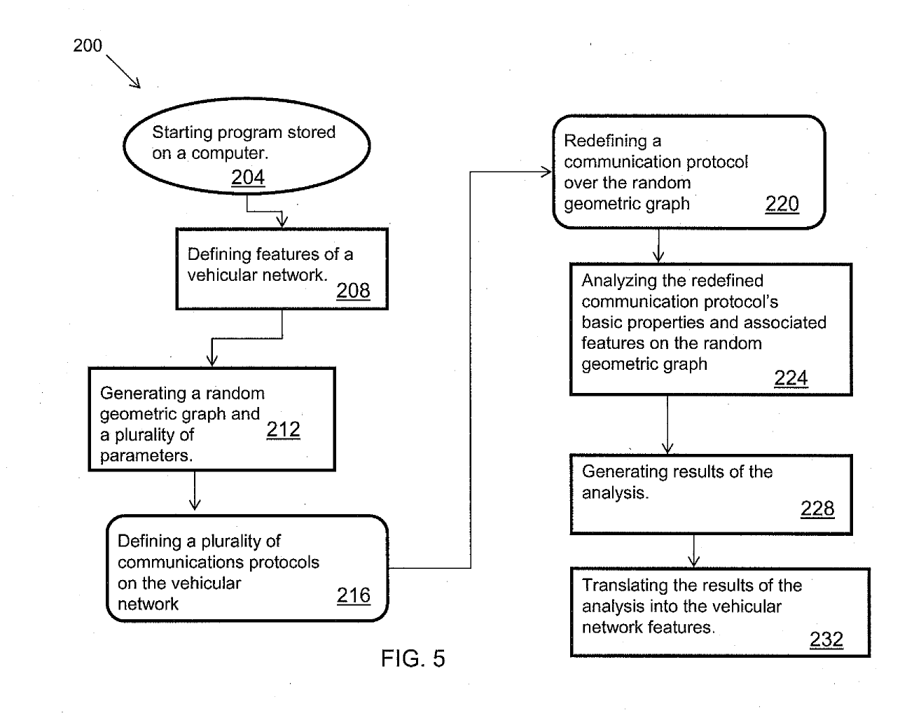

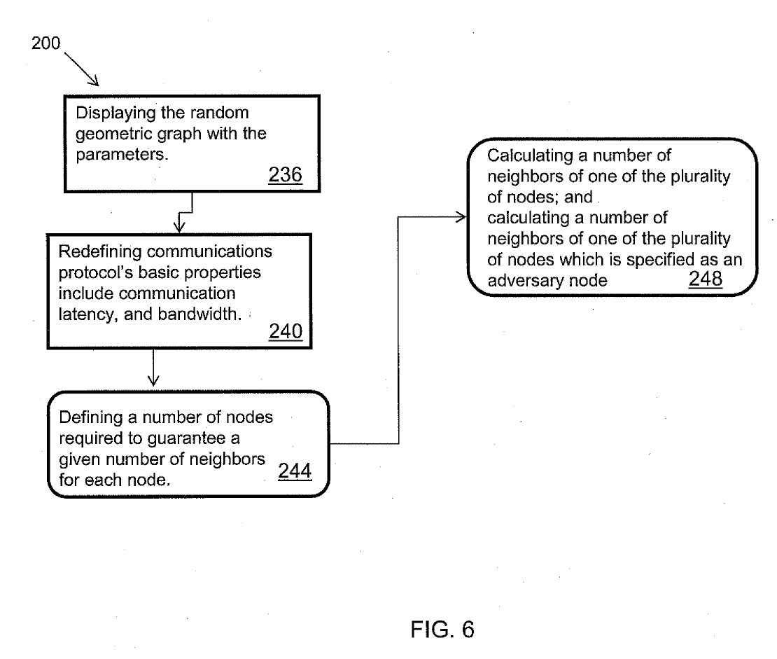

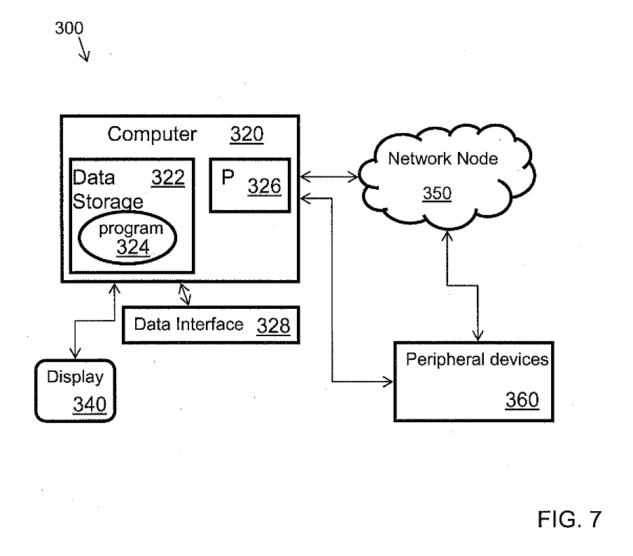

Referring to the flow chart shown in FIGS. 5 and 6, a method 200 according to an embodiment of the invention, generates a mathematical model of a vehicular communications network. The method uses a computer including a non-transitory computer readable storage medium encoded with a computer program embodied therein, as shown in FIG. 7. The computer program is started in step 204. Step 208 includes defining features of a vehicular network. The features may include: a graph of a street map within a geographic area; a number of vehicles within the geographic area; and a driving distribution pattern of the vehicles. Step 212 includes generating a random geometric graph with a plurality of parameters. Step 216 includes defining a plurality of communications protocols on the vehicular network. In step 220, the method 200 redefines a communication protocol over the random geometric graph. Step 224 includes analyzing the redefined communication protocol's basic properties and associated features on the random geometric graph. In step 228, the method 200 generates results of the analysis. Step 232 includes translating the results of the analysis into the vehicular network features. Step 236 includes displaying the random geometric graph with the parameters. The parameters may include: a number of graph nodes, and a probability that any two nodes are communicably connected.

The method 200 may further include a step 240 including the redefined communications protocol's basic properties include communication latency, and bandwidth. Step 244 may include defining a number of nodes required to guarantee a given number of neighbors for each node. Step 248 includes calculating a number of neighbors of one of the plurality of nodes; and calculating a number of neighbors of one of the plurality of nodes which is specified as an adversary node.

Referring to FIG. 6, a computer system 300 according to an embodiment of the invention, may be used in conjunction with, or as part of, a server node, vehicle computer or other static or mobile devices, and includes a computer 320. The computer 320 includes a data storage device 322 and a software program 324, for example, an operating system or a program implementing instructions to achieve a result. The software program or operating system 324 is stored in the data storage device 322, which may include, for example, a hard drive, or flash memory, or other non-transitory computer readable storage medium. The processor 326 executes the program instructions from the program 324. The computer 320 may be connected to a network 350, which may include, for example, the Internet, a local area network (LAN), or a wide area network (WAN). The computer 320 may also be connected to a data interface 328 for entering data and a display 340 for displaying information to a user. A peripheral device 360 may also be connected to the computer 320.

As will be appreciated by one skilled in the art, aspects of the embodiments of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may be referred to as a “circuit,” “module” or “system.” Furthermore, aspects of the present invention may take the form of a computer program product embodied in one or more computer readable medium(s) having computer readable program code embodied thereon. Further, combinations of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. A computer readable storage medium may be any tangible medium that can contain, or store a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing. Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described with reference to flowchart illustrations and/or block diagrams of methods, apparatus (and/or systems), and computer program products according to embodiments of the invention. It will be understood that blocks of the flowchart illustrations and/or block diagrams, and combinations of blocks in the flowchart illustrations and/or block diagrams, may be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved.

While the present invention has been particularly shown and described with respect to preferred embodiments thereof, it will be understood by those skilled in the art that changes in forms and details may be made without departing from the spirit and scope of the present application. It is therefore intended that the present invention not be limited to the exact forms and details described and illustrated herein, but falls within the scope of the appended claims.

What is claimed is:

1. A method for generating mathematical analysis results of a communication protocol in a vehicular communications network using a computer including a non-transitory computer readable storage medium encoded with a computer program embodied therein, comprising:
defining features of a vehicular network, the features including: a graph of a street map within a geographic area; a number of vehicles within the geographic area; specified conditions for vehicles to communicate; and a driving distribution pattern of the vehicles;
generating a random geometric graph with a plurality of parameters;
defining a plurality of communications protocols on the vehicular network;
redefining a communication protocol over the random geometric graph;
analyzing a communication protocol's basic properties and associated features on the random geometric graph;
generating results of the analysis;
translating the results of the analysis based on the random geometric graph's parameters into results based on the vehicular network features; and
displaying the random geometric graph with the parameters, the parameters including: a number of graph nodes; and a probability that any two nodes are communicably connected being expressed as a function of the vehicular network features.

2. The method of claim 1, wherein the communications protocol's basic properties include: communication latency, and bandwidth; and wherein the associated features include: a number of nodes required to guarantee a given number of neighbors for each node.

3. The method of claim 1, wherein the translating step comprises combining the results of the communication protocol's analysis based on the random geometric graph's parameters with the expression calculating the random geometric graph parameters as a function of the vehicular network features.

4. The method of claim 1, further comprising:
calculating a number of neighbors of one of the plurality of nodes; and
calculating a number of neighbors of one of the plurality of nodes which is specified as an adversary node.

5. The method of claim 1, wherein at least a portion of the communication nodes are mobile.

6. The method of claim 1, further comprising:
calculating how many infrastructure mobile servers are required to attain a specified connectivity between the plurality of vehicles.

7. A method for generating a mathematical model including analysis results of a vehicular communications network using a computer including a non-transitory computer readable storage medium encoded with a computer program embodied therein, comprising:
defining a vehicular communications network including a plurality of vehicles using the computer program;
defining a plurality of communication nodes communicating with the plurality of vehicles;
defining features of the vehicular communications network, including: geographic locations; mobility features; and communication features;
generating a geographical model, a mobility model, and a communication model of the vehicular communications network using the computer program;
generating a spatial distribution of the plurality of vehicles defining locations in relation to time of the plurality of vehicles in the vehicular communications network;
calculating a probable radius of location for each of the plurality of communications nodes;
defining a radius parameter for each of the plurality of vehicles such that each of the plurality of vehicles communicates within the radius parameter;
calculating a probability that two edges of the probable radiuses intersect using the spatial distribution, such that a distance between the communication nodes is smaller than the radius parameter;
generating a mathematical model of the vehicular communications network;
generating a random geometric graph with a plurality of parameters; and
displaying the random geometric graph on a display.

8. The method of claim 7, further comprising:
providing a plurality of communications protocols on the vehicular network;
redefining a communication protocol over the random geometric graph;
analyzing the redefined communication protocol's basic properties and associated features on the random geometric graph;
generating results of the analysis;
translating the results of the analysis based on the random graph's parameters into results based on the vehicular network features; and
displaying the random geometric graph with the parameters on the display, the parameters including: a number of graph nodes; and a probability that any two nodes are communicably connected being expressed as a function of the vehicular network features.

9. The method of claim 7, wherein the communications protocol's basic properties include: communication latency, and bandwidth; and wherein the associated features include: how many nodes are needed to guarantee a given number of neighbors for each node.

10. The method of claim 7, the features including: a graph of a street map within a geographic area; a number of vehicles within the geographic area; and a driving distribution pattern of the vehicles.

11. The method of claim 7, wherein a Certificate Revocation List (CRL) is sent between the plurality of vehicles, and between the plurality of communication nodes and the plurality of vehicles.

12. The method of claim 7, further comprising:
calculating a number of neighbors of one of the plurality of nodes.

13. The method of claim 7, further comprising:
calculating a number of neighbors of one of the plurality of nodes being specified as an adversary node.

14. The method of claim 7, further comprising:
providing a specified number of communication nodes in the vehicular communications network.

15. The method of claim 7, wherein at least a portion of the communication nodes are mobile.

16. The method of claim 7, further comprising:
calculating how many infrastructure mobile servers are required to attain a specified connectivity between the plurality of vehicles.

17. The method of claim 7, wherein the geographical model includes a Manhattan Grid Mobility model (MGMM).

18. A computer program product comprising a non-transitory computer readable medium having recorded thereon a computer program, a computer system including a processor for executing the steps of the computer program for generating a mathematical model, the program steps comprising:
defining features of a vehicular network, the features including: a
graph of a street map within a geographic area; a number of vehicles within the geographic area; specified conditions for vehicles to communicate; and a driving distribution pattern of the vehicles;
generating a random graph with a plurality of parameters;
defining a plurality of communications protocols on the vehicular network;
redefining a communication protocol over the random graph;
analyzing a communication protocol's basic properties and associated features on the random graph;
generating results of the analysis;
translating the results of the analysis based on the random graph's parameters into results based on the vehicular network features; and
displaying the random graph with the parameters, the parameters including: a number of graph nodes, a probability that any two nodes are communicably connected being expressed as a function of the vehicular network features.

19. The computer program product of claim 18, wherein the communications protocol's basic properties include: communication latency, and bandwidth; and wherein the associated features include: a number of nodes required to guarantee a given number of neighbors for each node.
